(19) United States
(12) Patent Application Publication
(10) Pub. No.: US 2026/0326139 A1
(43) Pub. Date: Oct. 22, 2026

(54) ANGLE-ADJUSTABLE WATER SPRAY GUN

(71) Applicant: YI FENG PRECISION TECH CO., LTD., TAICHUNG CITY (TW)

(72) Inventor: Ho-Chin CHEN, TAICHUNG CITY (TW)

(21) Appl. No.: 19/407,690

(22) Filed: Dec. 3, 2025

(30) Foreign Application Priority Data
Apr. 21, 2025 (TW) 114115017

(51) Int. Cl. B05B 15/68; B05B 9/01; B05B 12/00

(52) U.S. Cl. CPC B05B 15/68; B05B 9/01; B05B 12/002

(57) ABSTRACT

An angle-adjustable water spray gun includes a handle, a nozzle, a switch assembly, and a fastening member. A first pivot portion of the handle is pivotally connected to a second pivot portion of the nozzle, such that the nozzle is pivotable relative to the handle. The switch assembly is disposed between the handle and the nozzle for controlling the water output of the spray gun. The fastening member has a first end portion and a second end portion respectively assembled on the outer sides of the first pivot portion of the handle and the second pivot portion of the nozzle, such that the first pivot portion of the handle and the second pivot portion of the nozzle are clamped by the fastening member. Accordingly, due to the arrangement of the fastening member, the connection between the handle and the nozzle is tightly fitted, thereby preventing water leakage.

### BACKGROUND OF THE INVENTION

### 1. Field of the Invention

The present invention relates to water spray guns and more particularly, to a water spray gun in which a handle and a nozzle are pivotally coupled to each other, thereby enabling adjustment of the spray angle.

### 2. Description of the Related Art

In gardening work, a handheld water spray gun is commonly used to connect with a water hose. The structure of a conventional spray gun generally includes a handle, a nozzle, a switch, and a connecting member. The user can adjust the nozzle to achieve different spray patterns and control the water flow rate through the switch.

TW I559983 discloses a water spray gun structure, in which a rotating knob is used to drive a water control valve and a stopper to change the angle of the water control valve. By aligning the water inlet hole of the valve with the outlet hole, water can flow smoothly to achieve the water-dispensing function. Alternatively, by partially blocking the water inlet hole with the peripheral wall of the control chamber, the water flow rate can be adjusted to provide either a large or small volume of water for irrigation. However, although this type of spray gun allows adjustment of the water flow rate, the angle between the barrel portion and the handle portion cannot be adjusted. Under different working environments, the user can only change the spraying direction by manually adjusting the wrist angle, which increases wrist fatigue.

Some existing spray guns provide an angle-adjustable structure, typically by disposing a shaft or a universal joint-like connector between the nozzle and the handle, so that the nozzle can be pivoted relative to the handle. However, such spray guns are generally made of plastic materials, resulting in poor sealing between the nozzle and the handle. The connection typically relies solely on a sealing ring to enhance tightness, but its pressure resistance is limited. As a result, the joint between the nozzle and the handle often becomes loose and leaks during use, and may even crack under high water pressure.

Accordingly, how to provide a water spray gun that allows angle adjustment while enhancing the structural strength of the spray gun to prevent leakage or damage during use is the problem that the inventor seeks to address.

### SUMMARY OF THE INVENTION

It is a primary objective of the present invention to provide a water spray gun, which reinforces the structural strength at the pivot connection to prevent water leakage or damage during use.

To attain the above objective, the water spray gun of the present invention comprises a handle, a nozzle, a switch assembly, and a fastening member. The handle has a handle body connected with a water source, an inlet passage disposed inside the handle body, and a first pivot portion provided at one end of the handle body and communicating with the inlet passage. The nozzle has a nozzle body, an outlet passage disposed inside the nozzle body, and a second pivot portion communicating with the outlet passage. The second pivot portion of the nozzle is pivotally connected to the first pivot portion of the handle, such that the nozzle is pivotable relative to the handle. The switch assembly is disposed between the handle and the nozzle, and includes a toggle member and a control shaft disposed on the toggle member. The control shaft is driven by the toggle member to rotate between a first position where the inlet passage of the handle and the outlet passage of the nozzle are not in communication with each other and a second position where the inlet passage of the handle and the outlet passage of the nozzle are in communication with each other. The fastening member has a first end portion disposed on an outer side of the first pivot portion of the handle, and a second end portion connected to the first end portion and disposed on an outer side of the second pivot portion of the nozzle, such that the first pivot portion of the handle and the second pivot portion of the nozzle are clamped by the fastening member.

It can be seen from the above that the handle and the nozzle are connected through the first pivot portion and the second pivot portion serving as a bending structure, whereby the nozzle can be rotated. An angle between the nozzle and the handle is adjustable from 90 degrees to 180 degrees, thereby enhancing the convenience of use of the water spray gun. Furthermore, the fastening member reinforces the coupling relationship between the handle and the nozzle by securing the first pivot portion and the second pivot portion. Even under high water pressure, the fastening member firmly holds the handle and the nozzle in position, preventing water leakage from the joint between the first and second pivot portions and improving the pressure resistance of the water spray gun.

Preferably, the control shaft extends through a first through hole of the first pivot portion of the handle and a second through hole of the second pivot portion of the nozzle. Accordingly, the control shaft, which is located between the handle and the nozzle, can control opening and closing of the water flow.

Preferably, the first pivot portion of the handle is formed with a plurality of positioning holes, and the second pivot portion of the nozzle is formed with a positioning groove. A positioning member is received in the positioning groove and is engageable with one of the positioning holes. Accordingly, the positioning member is engageable with different positioning holes according to the pivoting angle of the nozzle, thereby providing precise positioning functionality and preventing the nozzle from swinging freely during use.

Preferably, the control shaft has a flow passage and a water-blocking portion, such that when the control shaft is rotated to the first position, the water-blocking portion is located between the inlet passage and the outlet passage, and when the control shaft is rotated to the second position, the flow passage is located between the inlet passage and the outlet passage. Accordingly, the water-blocking portion serves as a barrier structure between the inlet passage and the outlet passage, and is capable of completely or partially blocking an area between the second pivot portion and the outlet passage so as to control the water flow rate of the nozzle.

Preferably, the water-blocking portion penetrates through one side of the control shaft, and a sealing pad is provided on the water-blocking portion. Accordingly, a separate component may be installed on the water-blocking portion, such as the sealing pad. When the sealing pad becomes worn, it can be individually replaced to restore the sealing effect.

Preferably, the control shaft has two end caps, and the toggle member has two side holes sleeved onto the end caps. Accordingly, the toggle member drives the control shaft to rotate through the two end caps, allowing the control shaft to be rotated relative to the first pivot portion and the second pivot portion.

Preferably, the fastening member is made of a metallic material. Accordingly, the fastening member provides a more secure fixing effect, making the joint between the handle and the nozzle less prone to loosening or damage.

Preferably, the fastening member further includes a connecting structure having one end connected to the first end portion and another end connected to the second end portion, such that the first end portion, the second end portion, and the connecting structure jointly define a fastening space that accommodates the first pivot portion of the handle and the second pivot portion of the nozzle. The first end portion of the fastening member is fixed between the toggle member and the first pivot portion of the handle, and the second end portion of the fastening member is fixed between the toggle member and the second pivot portion of the nozzle. Accordingly, the fastening member is positioned on an inner side of the toggle member and directly fastens the first pivot portion and the second pivot portion, thereby achieving a more stable fixing effect.

Preferably, an outer circumferential surface of the connecting structure is formed with an engaging groove, and the first pivot portion of the handle extends outward to form an engaging portion engaged in the engaging groove of the connecting structure. Accordingly, the handle and the fastening member are engaged with each other in an interlocking manner, allowing the fastening member to more firmly secure the handle and the nozzle.

Preferably, the control shaft extends through a first aperture of the first end portion of the fastening member and the second aperture of the second end portion of the fastening member.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a perspective view of the present invention, showing that the handle and the nozzle are in the straight state;

FIG. 2 is a perspective view of the present invention, showing that the nozzle is bent at a 90-degree angle relative to the handle;

FIG. 3 is a perspective view of the present invention, showing that the nozzle is bent at a 135-degree angle relative to the handle;

FIG. 4 is an exploded view of the present invention;

FIG. 5 is an enlarged view of FIG. 4, showing the combination relationship between the first pivot portion and the second pivot portion;

FIG. 6 is similar to FIG. 5, showing another perspective of FIG. 5;

FIG. 7 is an exploded view of a switch assembly of the present invention.

FIG. 8 is a perspective view of a fastening member of the present invention;

FIG. 9 is a partial sectional view of the present invention, showing a water-off state;

FIG. 10 is a partial sectional view of the present invention, showing a fully open state; and

FIG. 11 is a partial sectional view of the present invention, showing a half-open state.

### DETAILED DESCRIPTION OF THE INVENTION

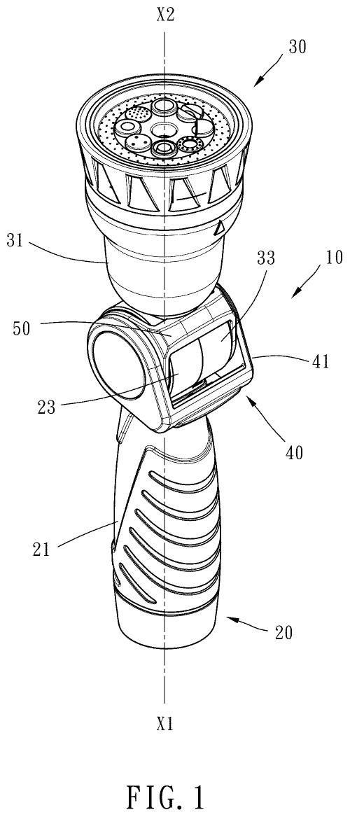

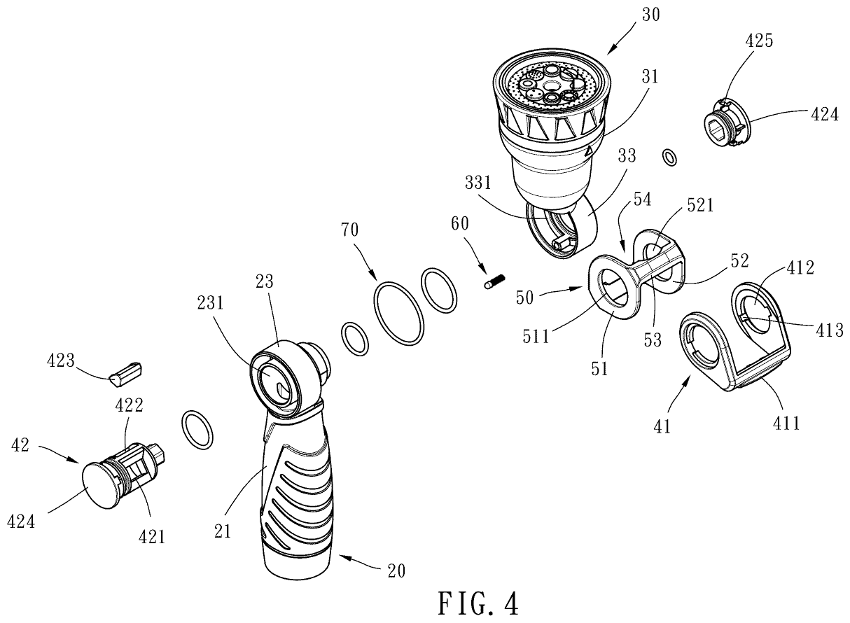

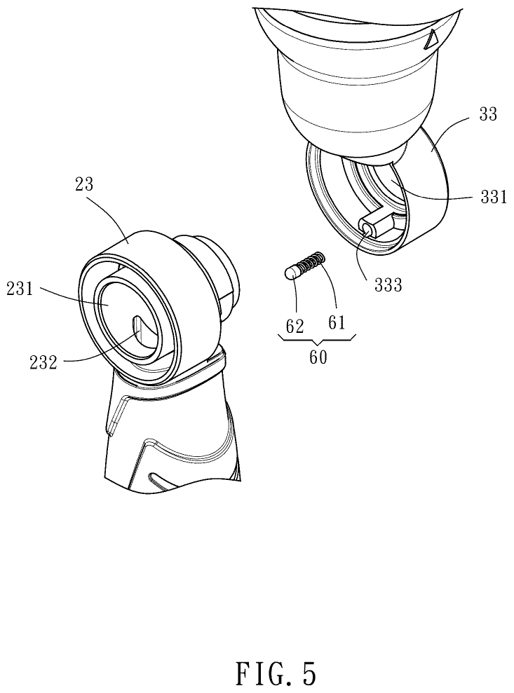

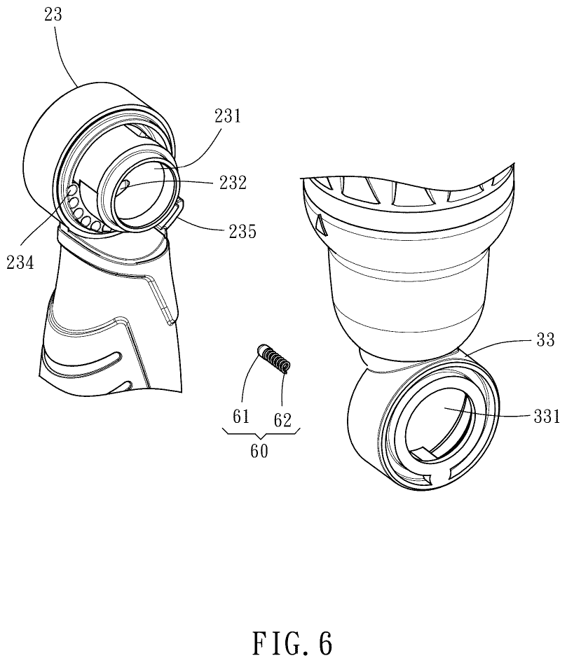

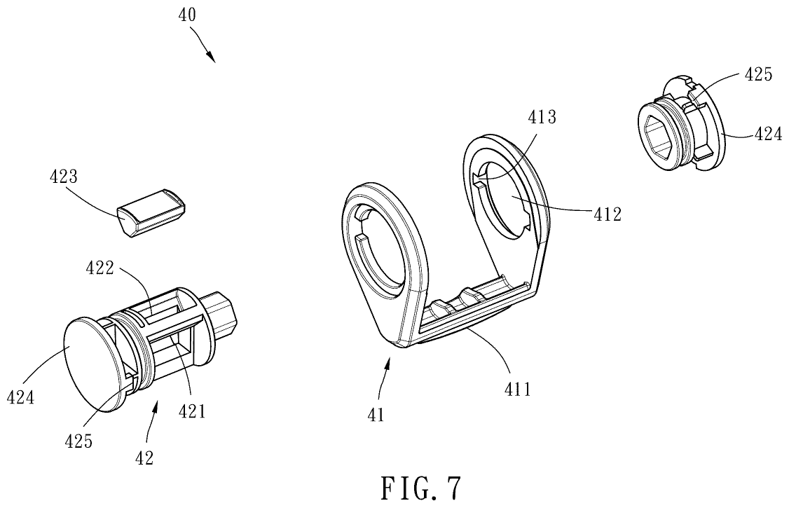

Please refer to FIGS. 1 to 8, a water spray gun 10 of the present invention comprises a handle 20, a nozzle 30, a switch assembly 40, a fastening member 50, and a positioning member 60.

The handle 20 includes a handle body 21, an inlet passage 22 disposed inside the handle body 21, and a first pivot portion 23 provided at a top end of the handle body 21. The first pivot portion 23 is an annular structure and provided with a first through hole 231, an inlet 232 communicating with the inlet passage 22, and an outlet 233 communicating with the nozzle 30.

The nozzle 30 includes a nozzle body 31, an outlet passage 32 disposed inside the nozzle body 31, and a second pivot portion 33 provided at a bottom end of the nozzle body 31. The second pivot portion 33 is an annular structure and pivotally connected to the first pivot portion 23 of the handle 20, such that the nozzle 30 is pivotable relative to the handle 20. The second pivot portion 33 is provided with a second through hole 331 and an outlet 332 communicating with the outlet passage 32 and the first pivot portion 23.

The nozzle 30 is rotatable relative to the handle 20 between a bent state and a straight state, such that an angle between the two can be varied from 90 degrees to 180 degrees. An axis of the handle 20 is defined as a first axial direction X1, and an axis of the nozzle 30 is defined as a second axial direction X2.

When the handle 20 and the nozzle 30 are in the straight state, the angle between the first axial direction X1 and the second axial direction X2 can be extended to 180 degrees, as shown in FIG. 1.

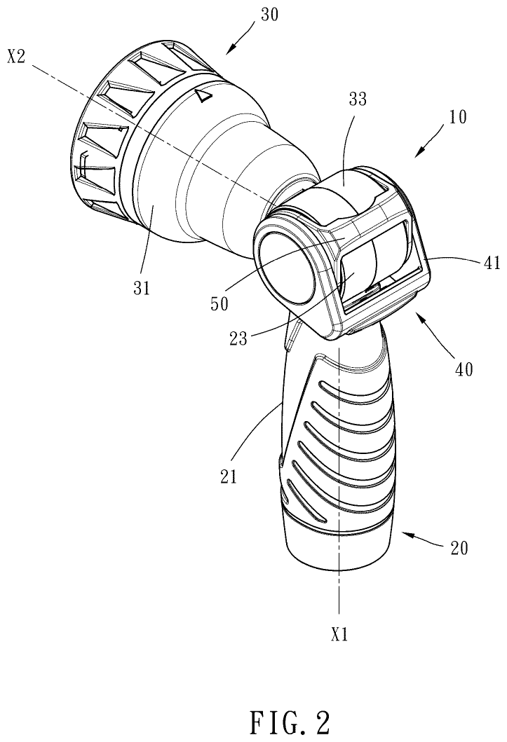

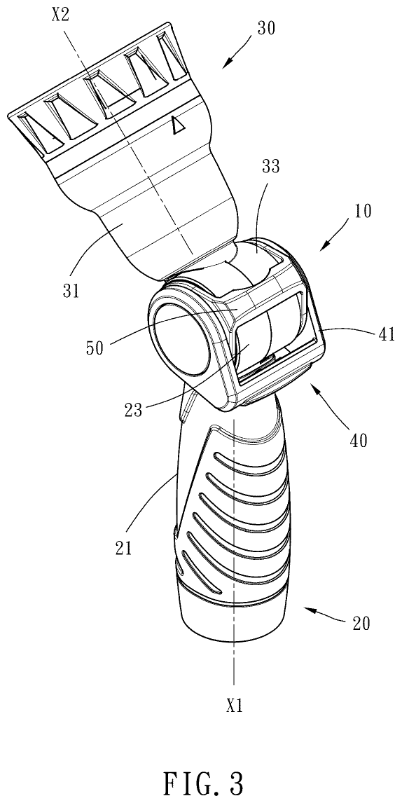

When the nozzle 30 and the handle 20 are in the bent state, the angle between the first axial direction X1 and the second axial direction X2 is less than 180 degrees, for example, 90 degrees as shown in FIG. 2 or 135 degrees as shown in FIG. 3, and within the range between 90 degrees and 180 degrees, the handle 20 and the nozzle 30 can be bent and positioned at any angle.

Additionally, on a side of the first pivot portion 23 facing the second pivot portion 33, a plurality of positioning holes 234 are formed, while on a side of the second pivot portion 33 facing the first pivot portion 23, a positioning groove 333 is formed. The positioning member 60 is a combination of a spring 61 and a steel ball 62, wherein the spring 61 is received in the positioning groove 333 with one end abutted against a bottom of the positioning groove 333, and the other end protruding outward from the positioning groove 333 and abutted against the steel ball 62.

During rotation of the nozzle 30 by the user, the steel ball 62 pushes against the spring 61 to compress the spring 61. When the positioning member 60 reaches another positioning hole 234, the compressed spring 61 rebounds and pushes the steel ball 62 to engage in the corresponding positioning hole 234, thereby fixing the rotational angle of the nozzle 30.

The switch assembly 40 is disposed between the handle 20 and the nozzle 30, and includes a toggle member 41 and a control shaft 42.

The toggle member 41 has an operation portion 411 and two side holes 412. The operation portion 411 is located between the two side holes 412, and the two side holes 412 are formed on circular plates at both ends of the operation portion 411. A recess 413 is further formed around each of the side holes 412.

The control shaft 42 has a flow passage 421 and a water-blocking portion 422. A sealing pad 423 is mounted on the water-blocking portion 422, allowing the water-blocking portion 422 and the flow passage 421 to switch from a mutually communicated state to a non-communicated state. It is worth mentioning that the water-blocking portion 422 may alternatively be formed as a solid structure without the need to additionally install the sealing pad 423.

The control shaft 42 is further provided with two end caps 424. In this embodiment, one of the end caps 424 is fixed at one end of the control shaft 42, and the other end cap 424 is detachably assembled to the other end of the control shaft 42. In this way, the control shaft 42 can first be inserted through the first through hole 231 of the first pivot portion 23 of the handle 20 and the second through hole 331 of the second pivot portion 33 of the nozzle 30, and then the detachable end cap 424 is mounted to position the control shaft 42 between the handle 20 and the nozzle 30. In addition, the inner surfaces of the end caps 424 are each formed with a protrusion 425, allowing the toggle member 41 to engage the protrusions 425 through the recesses 413, thereby enabling the toggle member 41 and the control shaft 42 to move in a linked manner.

The fastening member 50 is made of a metallic material and includes a first end portion 51, a second end portion 52, and a connecting structure 53

The first end portion 51 and the second end portion 52 are both hollow annular plates. The first end portion 51 is provided with a first aperture 511, and the second end portion 52 is provided with a second aperture 521.

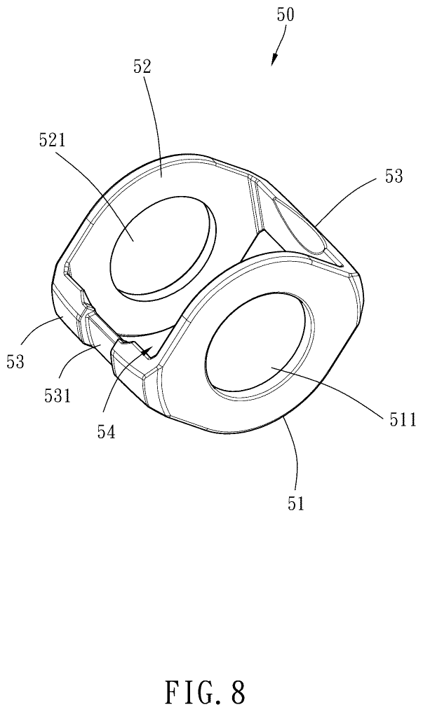

The connecting structure 53 is connected with the first end portion 51 and the second end portion 52. The connecting structure 53 is formed with two rectangular plates, each having one end connected to the first end portion 51 and the other end connected to the second end portion 52. An outer circumferential surface of one of the plates is recessed to form an engaging groove 531, as shown in FIG. 8. A fastening space 54 is jointly defined among the first end portion 51, the second end portion 52, and the connecting structure 53.

During assembly of the fastening member 50, the first pivot portion 23 of the handle 20 is inserted into the fastening space 54 of the fastening member 50, followed by inserting the second pivot portion 33 of the nozzle 30 so that the second pivot portion 33 fits over the first pivot portion 23, while an engaging portion 235 of the handle 20 simultaneously is engaged with the engaging groove 531. At this time, the first end portion 51 of the fastening member 50 is located on an outer side of the first pivot portion 23 of the handle 20, and the second end portion 52 of the fastening member 50 is located on an outer side of the second pivot portion 33 of the nozzle 30, such that the first pivot portion 23 and the second pivot portion 33 are clamped and tightened by the fastening member 50. This arrangement enhances the structural strength of the connection between the handle 20 and the nozzle 30. Since the fastening member 50 is made of a metallic material, it can also prevent deformation under high water pressure, thereby providing a more secure fixing effect for the first pivot portion 23 and the second pivot portion 33.

Subsequently, the control shaft 42 sequentially passes through the first aperture 511, the first through hole 231, the second through hole 331, and the second aperture 521. Finally, the toggle member 41 is assembled onto the control shaft 42, and the first end portion 51 of the fastening member 50 is fixed between the toggle member 41 and the first pivot portion 23, and the second end portion 52 of the fastening member 50 is fixed between the toggle member 41 and the second pivot portion 33. The toggle member 41 also secures the fastening member 50 in position, further enhancing the fastening effect of the fastening member 50.

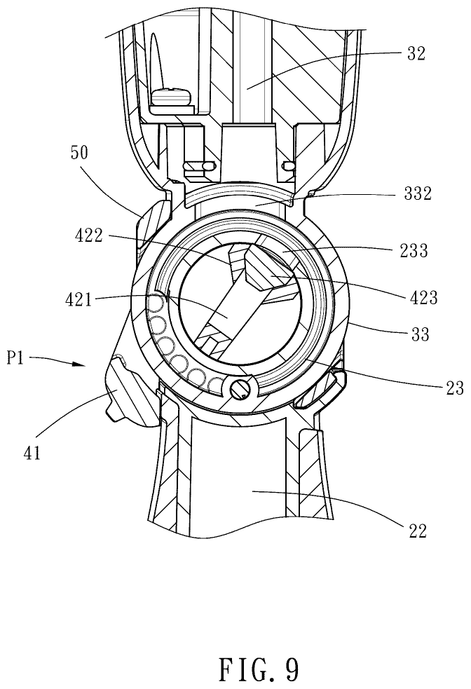

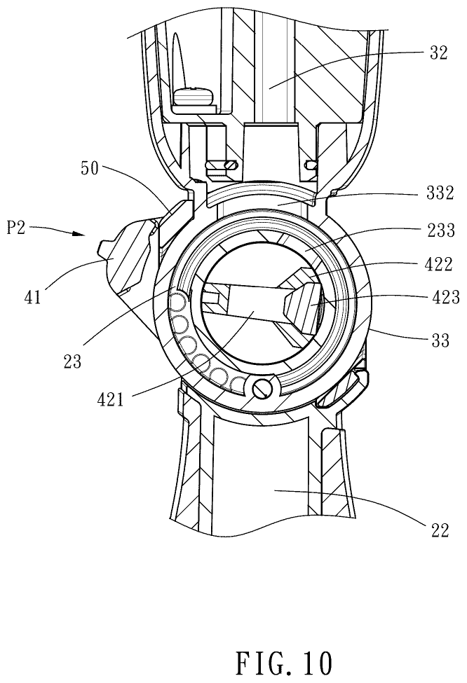

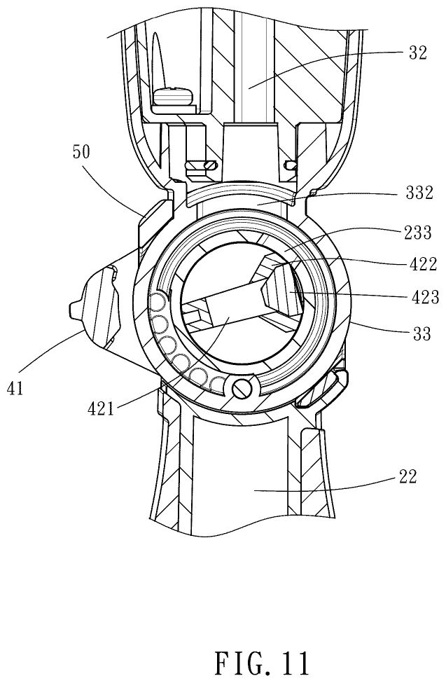

Referring to FIGS. 9 to 11, when the user operates the water spray gun 10, a water source is first connected to the bottom end of the handle body 21. After the water source is turned on, water flows into the inlet passage 22 and then to the first pivot portion 23. The toggle member 41 drives the control shaft 42 to rotate between a first position P1 and a second position P2. The first position P1 represents a water-off state of the spray gun 10, in which water cannot be sprayed from the nozzle 30, while the second position P2 represents a water-on state, in which water can be sprayed from the nozzle 30.

When the toggle member 41 is located at the first position P1, the sealing pad 423 blocks the outlet 233, so that the inlet passage 22 of the handle 20 and the outlet passage 32 of the nozzle 30 are in a non-communicated state. In this condition, water remains within the inlet passage 22 and the first pivot portion 23 and cannot flow out through the outlet 233.

Furthermore, since the control shaft 42 is provided with the flow passage 421, water fills the first through hole 231 through the flow passage 421. The sealing ring 70, the end caps 424, and the fastening member 50 are cooperated to prevent water leakage outward.

When the user intends to perform watering, the toggle member 41 is flipped upward by operating the operation portion 411, thereby driving the control shaft 42 to rotate. When the control shaft 42 is rotated to the second position P2, the sealing pad 423 is completely moved away from the outlet 233, thereby allowing the first pivot portion 23 to communicate with the second pivot portion 33. In this state, the inlet passage 22 of the handle 20 and the outlet passage 32 of the nozzle 30 are in a communicated state, and water within the first pivot portion 23 flows to the second pivot portion 33, then through the outlet 332 of the second pivot portion 33 to the outlet passage 32, enabling the nozzle 30 to spray water at its maximum flow rate.

In addition, the user may adjust the water flow rate. When the control shaft 42 is rotated to a position between the first position P1 and the second position P2, the sealing pad 423 partially blocks the outlet 233 of the first pivot portion 23. Although the first pivot portion 23 remains in communication with the second pivot portion 33, only a portion of the water passes through the outlet 233 of the first pivot portion 23, thereby reducing the amount of water flowing to the outlet passage 32. As a result, the nozzle 30 sprays water at a reduced flow rate instead of the maximum flow rate.

In summary, the water spray gun 10 provided by the present invention offers at least the following advantages over the prior art:
1. The handle 20 and the nozzle 30 are connected through a pivot structure, allowing the nozzle 30 to be pivoted relative to the handle 20, so that the spraying angle can be adjusted. Compared with conventional spray devices that cannot adjust the spraying angle, the present invention enhances the convenience of use of the water spray gun 10.
2. The water spray gun 10 of the present invention utilizes the fastening member 50 to strengthen the coupling relationship between the handle 20 and the nozzle 30. The first pivot portion 23 of the handle 20 and the second pivot portion 33 of the nozzle 30 are positioned inside the fastening member 50 and are secured in a clamping and tightening manner, thereby preventing water leakage from the joint during use of the water spray gun 10. The fastening member 50 also improves the structural strength at the joint, preventing cracking of the first pivot portion 23 and the second pivot portion 33 caused by excessive water pressure.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A water spray gun comprising:
a handle having a handle body adapted for connecting with a water source, an inlet passage disposed inside the handle body, and a first pivot portion provided at one end of the handle body and communicating with the inlet passage;
a nozzle having a nozzle body, an outlet passage disposed inside the nozzle body, and a second pivot portion communicating with the outlet passage, wherein the second pivot portion of the nozzle is pivotally connected to the first pivot portion of the handle, such that the nozzle is pivotable relative to the handle;
a switch assembly disposed between the handle and the nozzle, the switch assembly including a toggle member and a control shaft disposed on the toggle member and driven by the toggle member to rotate between a first position where the inlet passage of the handle and the outlet passage of the nozzle are not in communication with each other and a second position where the inlet passage of the handle and the outlet passage of the nozzle are in communication with each other; and
a fastening member having a first end portion disposed on an outer side of the first pivot portion of the handle, and a second end portion connected to the first end portion and disposed on an outer side of the second pivot portion of the nozzle, such that the first pivot portion of the handle and the second pivot portion of the nozzle are clamped between inner sides of the fastening member.

2. The water spray gun as claimed in claim 1, wherein the control shaft extends through a first through hole of the first pivot portion of the handle and a second through hole of the second pivot portion of the nozzle.

3. The water spray gun as claimed in claim 1, further comprising a positioning member received in a positioning groove of the second pivot portion of the nozzle and engageable with one of positioning holes of the first pivot portion of the handle.

4. The water spray gun as claimed in claim 1, wherein the control shaft has a flow passage and a water-blocking portion, such that when the control shaft is rotated to the first position, the water-blocking portion is located between the inlet passage and the outlet passage, and when the control shaft is rotated to the second position, the flow passage is located between the inlet passage and the outlet passage.

5. The water spray gun as claimed in claim 4, wherein the water-blocking portion penetrates through one side of the control shaft, and a sealing pad is provided on the water-blocking portion.

6. The water spray gun as claimed in claim 1, wherein the control shaft has two end caps, and the toggle member has two side holes sleeved onto the end caps.

7. The water spray gun as claimed in claim 1, wherein the fastening member is made of a metallic material.

8. The water spray gun as claimed in claim 1, wherein the fastening member further includes a connecting structure having one end connected to the first end portion and another end connected to the second end portion, such that the first end portion, the second end portion, and the connecting structure jointly define a fastening space that accommodates the first pivot portion of the handle and the second pivot portion of the nozzle, and wherein the first end portion of the fastening member is fixed between the toggle member and the first pivot portion of the handle, and the second end portion of the fastening member is fixed between the toggle member and the second pivot portion of the nozzle.

9. The water spray gun as claimed in claim 8, wherein an outer circumferential surface of the connecting structure is formed with an engaging groove, and the first pivot portion of the handle extends outward to form an engaging portion engaged in the engaging groove of the connecting structure.

10. The water spray gun as claimed in claim 8, wherein the control shaft extends through a first aperture of the first end portion of the fastening member and a second aperture of the second end portion of the fastening member.
